(19) United States
(12) Patent Application Publication
(10) Pub. No.: US 2016/0330097 A1
(43) Pub. Date: Nov. 10, 2016

(54) METHOD FOR DETECTING DETOURED CONNECTION VIA ANONYMOUS NETWORK USING CHANGES IN ROUND TRIP TIMES

(71) Applicant: KOREA UNIVERSITY RESEARCH AND BUSINESS FOUNDATION, Seoul (KR)

(72) Inventors: Duk Yun Kim, Seoul (KR); Sungdeok Cha, Seoul (KR); Shinil Kwon, Seoul (KR); Sehun Jeong, Seoul (KR)

(73) Assignee: Korea University Research and Business Foundation, Seoul (KR)

(21) Appl. No.: 15/110,022

(22) PCT Filed: Jan. 5, 2015
(86) PCT No.: PCT/KR2015/000060

§ 371 Date: Jul. 6, 2016

(30) Foreign Application Priority Data
Jan. 6, 2014 (KR) 10-2014-0001281

(51) Int. Cl. H04L 12/26; H04L 29/08

(52) U.S. Cl. CPC H04L 43/0864; H04L 67/02

(57) ABSTRACT

Disclosed is a method for detecting a detoured connection via an anonymous network using changes in round trip times. In the method for detecting a detoured connection, a server receives a plurality of sequential requests constituting one service request; responds to the received plurality of requests; measures round trip times (RTTs) according to the requests and responses, respectively; and distinguishes whether there is a detoured connection to the service request on the basis of a difference between the measured round trip times.

### CROSS-REFERENCE TO RELATED APPLICATIONS

This application is a U.S. National Phase of International Application No. PCT/KR2015/000060, filed Jan. 5, 2015, which claims priority under 35 U.S.C. §119 to Korean Patent Application No. 10-2014-0001281, filed Jan. 6, 2014, in the Korean Intellectual Property Office. The entire contents of these applications are hereby incorporated by reference.

### BACKGROUND

1. Statement of the Technical Field

The present disclosure relates to a technique of detecting detoured access from a network and. More particularly, the present disclosure concerns a method of detecting detoured access by a user with a malicious intention who accesses a server while hiding a location or a communication path thereof using an anonymous network that guarantees anonymity on a network and a recording medium for recording the same.

2. Description of the Related Art

Nowadays, most web sites manage and log all packets or traffic generated in the course of Internet communication without being recognized by a user who accesses the packets or traffic. Search terms input to search windows of portal sites are used to calculate real-time search ranking and user preference, as well as location of the user obtained through an accessed Internet protocol (IP) address and a search pattern of the user, is used for marketing information.

If a user with a malicious intention changes a source IP from a packet in order to hide an IP address thereof, the packet is dropped from a router and a connection cannot be established in the case of a transmission control protocol (TCP). Therefore, it is very difficult to substantially perform communication by changing an IP itself. In order to perform cyber attack, users with a malicious intention have used a technique of hiding IP addresses thereof using a virtual private network (VPN) or a proxy server. However, even when the VPN or the proxy server is used, a provider of a relay server is not reliable and, if information of a relayed packet is provided to an investigation agency, etc., an actually accessed IP could be traced. A concept of overcoming this problem is an anonymous network such as the onion router (TOR) or ZenMate. The anonymous network may further include more unknown networks.

TOR, a representative anonymous network, provides an environment which enables a user to anonymously use the Internet using TOR dedicated browser. The TOR browser accesses a web server via three arbitrarily selected servers from among several thousands of servers in the whole world. An exit node, which is a final server among the three servers, accesses the web server instead of a user computer. Then, the web server is aware of only an IP of the exit node rather than an IP of the user computer. Therefore, when a user with a malicious intention uses TOR, the first originator that has actually transmitted a packet cannot be identified. Cases using TOR for cyber attack by making bad use of this fact are a growing trend.

Accordingly, a technical means for detecting detoured access or malicious access via an anonymous network and effectively cutting off such access has been demanded. “A Study on the Countermeasure of Cyber Attacks Using Anonymous Network”, Jeonghyun LEE, Kwanjoon AHN, Wonhyung PARK, and Jongin LIM, Convergence security journal, 2011, analyzes an anonymous network technology and introduces countermeasure. However, a technical measure capable of basically identifying detoured access has been still unknown.

### SUMMARY

In detecting detoured access via a conventional anonymous network, a detection method of an elementary level has been used in which only an HTTP header is checked or an IP block of an exit node of an anonymous network is presecured to regard access from a corresponding IP as malicious access. Therefore, the present solution is designed to overcome the limitation of accurate detection of access in the case in which a user with a malicious intention attempts to perform access by undisclosing/manipulating a header or using a replaced IP and to solve the problem of generating a possibility of private information leakage/intrusion when a method of obtaining client information by inserting a specific entity into a web page is used during access by a user.

According to an aspect of the present solution, provided herein is a method of detecting detoured access via an anonymous network. The method is performed by a server. The method comprises: receiving a plurality of sequential requests constituting one service request; responding to the received requests; measuring round trip times (RTTs) according to the requests and responses, respectively; and determining whether the service request is performed by detoured access based on a difference between the measured RTTs.

The determining may be performed by checking whether irregularity between the RTTs occurs due to passing through the anonymous network.

The determining may include: calculating a difference between a first RTT according to a first request among a plurality of RTTs and a second RTT according to a second request received by the server after responding to the first request among the RTTs; and estimating that the service request is performed by detoured access via the anonymous network when the calculated difference is above a preset threshold value.

The RTTs may be acquired by measuring times consumed until a client receives responses to requests after transmitting the requests to the server. The RTT may be acquired by measuring times consumed until the server receives subsequent requests according to responses to requests after responding to the requests.

The method may further comprise disconnecting access upon estimating that the service request is performed by detoured access using the anonymous network.

In another aspect of the present solution, provided herein is a method of detecting detoured access via an anonymous network. The method is performed by a server. The method comprises: receiving a hypertext transfer protocol (HTTP) request; transmitting a page file in response to the received HTTP request; measuring a first round trip time (RTT) according to a response to the page file; receiving a request for a resource file according to the response to the page file and transmitting the resource file; measuring a second RTT according to a response to the resource file; and determining whether the service request is detoured access by checking whether irregularity between RTTs occurs based on a difference between the measured first RTT and the measured second RTT.

The determining may include: calculating a difference between the first RTT and the second RTT; estimating that the service request is performed by detoured access via the anonymous network when the calculated difference is above a preset threshold value; and identifying a type of the anonymous network using a statistical distribution of the calculated difference when it is estimated that the service request is performed by detoured access via the anonymous network.

The first RTT may include a time delay caused by passing through the anonymous network and have a relatively larger value than the second RTT.

The first RTT may be a time consumed until the server receives a request for a first resource file from a client after transmitting a response to the page file to the client using a communication path between the server and the client, and the second RTT may be a time consumed until the server receives a request for a next resource file from the client after transmitting a response to the first resource file using a communication path between the server and a detoured client located on the anonymous network.

When a plurality of target signals for measuring the first RTT and the second RTT is present, each of the RTTs may be calculated by measuring signals having minimum arrival times among the target signals.

Meanwhile, a computer-readable recording medium is provided in which a program for executing the method of detecting detoured access via the anonymous network by a computer is recorded.

According to aspects of the present solution, a server can accurately detect detoured access via an anonymous network by checking irregularity based on whether there is a difference between RTTs according to attributes of files through analysis of traffic accessing the server. In addition, there is no additional burden on a network and a web server at all and an argument about privacy intrusion does not occur at all.

### BRIEF DESCRIPTION OF THE FIGURES

The above and other objects and features will become apparent from the following description with reference to the following figures, wherein like reference numerals refer to like parts throughout the various figures unless otherwise specified.

FIG. 1 is a view illustrating network intrusion via an anonymous network and an overview of a network intrusion structure.

FIG. 2A and FIG. 2B are views illustrating a communication scheme between a client and a server by way of example of an HTTP service.

FIG. 3A and FIG. 3B are views illustrating a difference in round trip times (RRTs) between direct communication between a client and a server and communication via an anonymous network.

FIG. 4 is a flowchart illustrating a method of detecting detoured access via an anonymous network.

FIG. 5A and FIG. 5B are views illustrating a method of measuring HTTP RTTs at a client side and a server side, respectively, in the detoured access detection method of FIG. 4.

FIG. 6A and FIG. 6B are views illustrating comparison of RTT measurement procedures using the detoured access detection method of FIG. 4 in a direct communication scheme and a communication scheme via an anonymous network.

FIG. 7 is a flowchart illustrating a method of detecting detoured access via an anonymous network according to an HTTP service request of the present solution.

FIG. 8 and FIG. 9 are views illustrating an experimental result of measuring RTTs under an assumption of various network environments.

### DETAILED DESCRIPTION

A method of detecting detoured access via an anonymous network according to the present solution includes: receiving, by a server, a plurality of sequential requests constituting one service request; responding, by the server, to the received requests; measuring, by the server, round trip times (RTTs) according to the requests and the responses, respectively; and determining, by the server, whether the service request is performed by detoured access based on a difference between the measured RTTs.

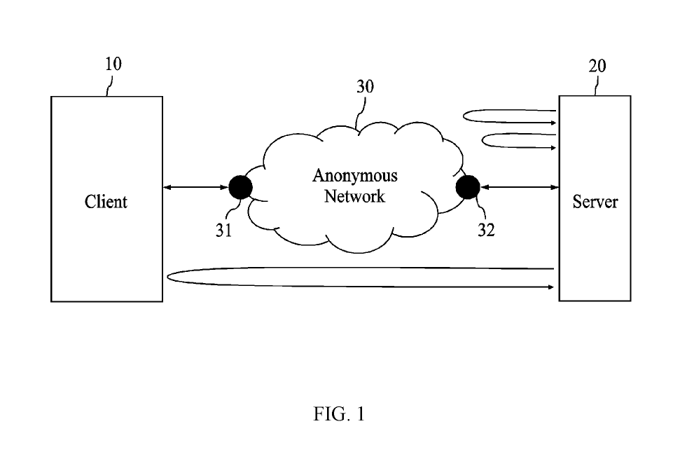

FIG. 1 is a view illustrating network intrusion via an anonymous network and an overview of a network intrusion structure. A description will be given based on TOR as an example of the anonymous network.

The purpose of establishing TOR by the U.S. Navy was to foster an environment in which an Internet user is capable of freely using the Internet without being regulated by a government or a specific organization. To this end, TOR is configured to place three nodes (an entry node, a middle node, and an exist node) between a web server 20 and a client 10 so that various operations that the client 10 accesses the web server 20 are not exposed. Since the client 10 communicates with an entry node 31 and the web server 20 communicates with the exit node 32, a client IP is not exposed. In addition, a communication in section between the client 10 and the exit node 32 is encrypted, thereby preventing exposure of information exchanged between the client 10 and the web server 20. TOR is widely used throughout the world due to convenience of use.

Referring to FIG. 1, it may be appreciated that targets with which the server 20 communicates are different in the case in which the server 20 directly communicates with the client 10 and the case in which the server 20 performs communication with the client 10 via an anonymous network 30. When the server 20 performs direct communication with the client 10, a packet that the server 20 transmits arrives directly at the client 10 and a packet that the client 10 transmits is directly received by the server 20. Therefore, the server 20 is aware of an Internet protocol (IP) of the client 10. In contrast, in the case of communication via the anonymous network 30, a packet that the server 20 transmits is received by the exit node 32 constituting the anonymous network 30 and the server 20 receives a response message from the exit node 32. Accordingly, the server 20 cannot be aware of a true IP of the client 10. An IP recognized by the server 20 is only an address of a false client (i.e., the exit node 32).

As described above, if the client 10 attempts to perform detoured access to the server 20 via the anonymous network 30, a problem of being not aware of whether such access is detoured access or not arises.

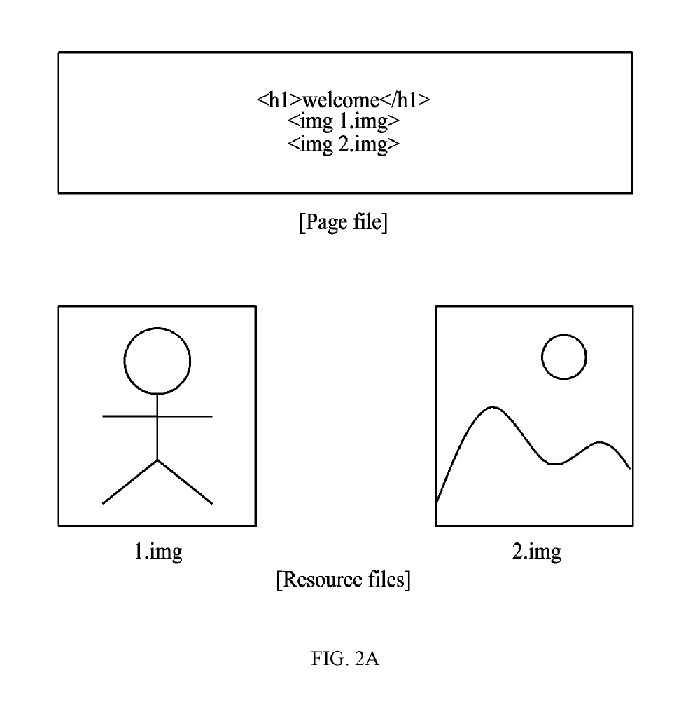

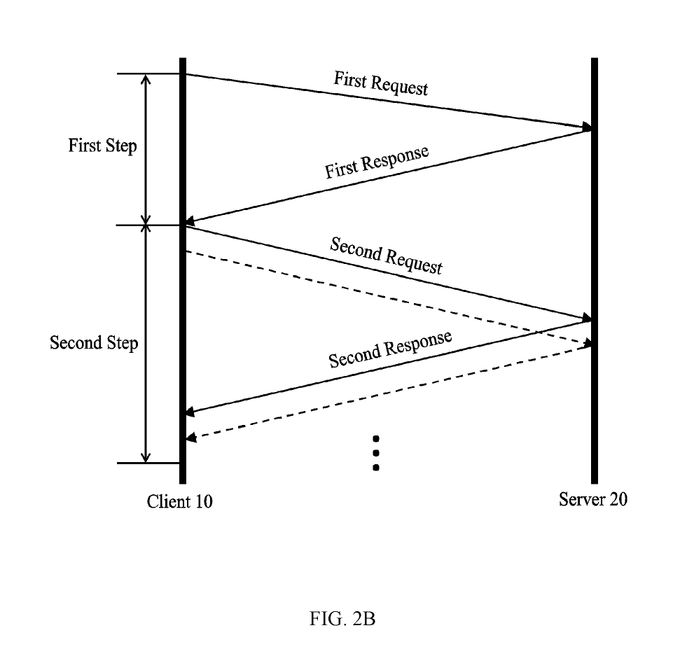

FIG. 2A and FIG. 2B are views illustrating a communication scheme between a client and a server by way of example of a hypertext transfer protocol (HTTP) service. Herein, only characteristics of communication of the HTTP service will be described in brief and problems generated in an anonymous network will be described in later.

Referring to FIG. 2A, one Internet homepage consists of one page file and multiple resource files connected to the page file. For example, a homepage including n flower drawings (where n is a natural number) consists of n image files and one page file binding the n image files in an HTML form.

A description of an Internet homepage access procedure will now be given with reference to FIG. 2B. A procedure of getting a homepage file in normal access broadly includes two steps.

In a first step, the client 10 gets a page file by accessing the web server 20. That is, the client 10 transfers a first request to the server 20 and receives a first response (page file) to the first request from the server 20. After the first step, the client 10 composes a list of resource files necessary for web page configuration by parsing the page file. In this case, when the resource files are present in a cache, the client 10 may exclude the corresponding files from the list.

In a second step, the client 10 accesses the web server 20 to retrieve the resource files included in the list. That is, the client 10 transfers a second request to the server 20 and receives a second response (a resource file) to the second request from the server 20.

It should be noted that the second step cannot be started unless the first step is performed and any access generated in the second step is not generated before the first step is completed. In contrast, since a procedure of getting multiple resource files in the second step may be performed in parallel regardless of an order, most commercial web browsers simultaneously access the web server and the multiple resource files are retrieved through respective accesses. FIG. 2B shows that two accesses (solid lines and dotted lines) are formed in the second step and a plurality of resource files is retrieved through the respective accesses.

The above-described procedure of accessing the Internet homepage will now be described focusing on a detoured access method via TOR.

In a first step, if the client 10 requests access to a specific homepage, an entry node constituting an anonymous network receives the request which is then transferred to an exit node via a middle node. Next, the exit node requests a corresponding page file by accessing the web server 20. The web server 20 transmits the page file to the exit node as a response to the request and the page file is transmitted to the client 10 via the middle node and the entry node. The client 10 reads the page file, compares the page file with a cache file stored therein, and composes a list of resource files necessary for webpage display.

In a second step, if the client 10 requests that the entry node simultaneously transfer the necessary resource files, the request is transmitted to the exit node via the middle node. The exit node sequentially requests that the web server 20 transmit the resource files. In this case, similarly to a commercial browser, a plurality of accesses may be simultaneously performed. The resource files received by the exit node from the server 20 as a response are finally transferred to the client 10 via the middle node and the entry node.

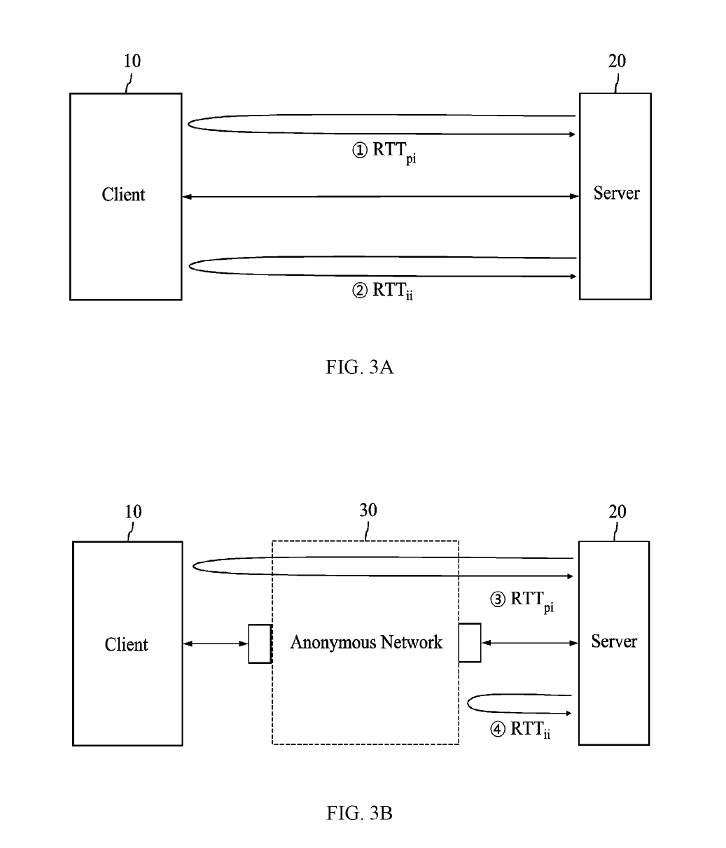

FIG. 3A and FIG. 3B are views illustrating differences in round trip times (RRTs) between direct communication between a client and a server and communication via an anonymous network.

Referring to FIG. 3A, in direction communication between the client 10 and the server 20, an RRT \textcircled{1}RTTₚᵢ consumed to transmit a page file and an RTT \textcircled{2}RTTᵢᵢ consumed to transmit a resource file (e.g., an image file) have no big difference in communication paths and are similar to each other in measured times.

Meanwhile, in detoured access via the anonymous network 30, there is a slight difference in the RTTs according to transmitted files. Referring to FIG. 3B, it is assumed that homepage access via TOR is performed. An RTT \textcircled{3}RTTₚᵢ consumed to transmit a page file by the server 20 and an RTT \textcircled{4}RTTᵢᵢ consumed to transmit a resource file (e.g., an image file) are different in communication paths and thus are different in measured times. That is, only when the page file first transmitted by the server 20 actually reaches the client 10, the client 10 can parse a web page and generate a list of contained resource files, whereas, once the list of the files is generated, the server 20 accesses the anonymous network 30 multiple times and makes a resource request and response through the anonymous network 30. Therefore, a communication path according to transmission of the page file is different from a communication path according to transmission of the resource file and RTTs are also different due to the different communication paths. Obviously, an RTT for transmitting the page file has a relatively larger value than an RTT for transmitting the resource file.

In consideration of differences in the transmission paths and the RTTs, the present solution uses different characteristics of RTTs according to attributes of files transmitted to detect traffic that accesses a homepage server via an anonymous network. Even in access via an anonymous network such as TOR as well as in direct access, a procedure of getting a page file and then parsing the page file is necessarily performed by the client 10. In contrast, there is a difference between access via the anonymous network and direct access in an operation of requesting a resource file. In normal access (indicating direct access that does not pass through the anonymous network), the client 10 directly requests that the server 20 transmit a resource file, whereas, in detoured access via the anonymous network 30, an exit node, instead of the client 10, requests that the server 20 transmit the resource file. As a result, in access via the anonymous network 30, a considerable time is consumed until the client 10 requests a first resource file after receiving a page file, whereas a time until the client requests a subsequent resource file after receiving the resource file is relatively short. That is, attributes are used in which an RTT consumed for most communication corresponds to communication between the server 20 and the anonymous network (a sort of a false client) 30, whereas communication for transmitting a specific file is performed between the server 20 and the real client 10. Such a difference in times does not occur in normal access.

Hereinafter, the present solution will be described in detail with reference to the attached drawings. In the following description and attached drawings, a detailed description of known functions or configurations will be omitted when it may obscure the subject matter of the present solution. The same reference symbols are used throughout the drawings to refer to the same or like parts.

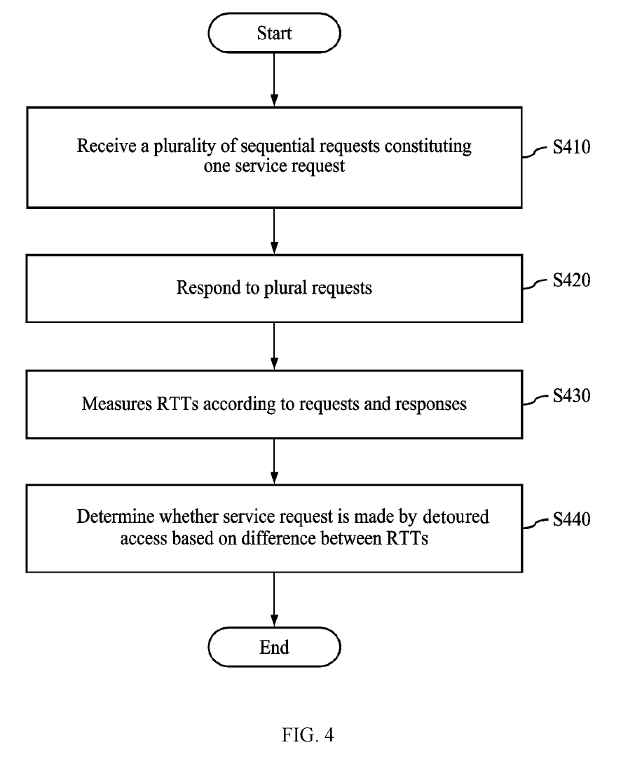

FIG. 4 is a flowchart illustrating a method of detecting detoured access detection via an anonymous network. The detoured access detection method includes the following steps. The steps may be implemented as a physical hardware device (e.g., a server) including at least one processor, a storage usable to process an operation, and a communication means and may be used together with a detection software for detecting detoured access using an anonymous network through traffic analysis in a web server.

In step S410, a server receives a plurality of sequential requests constituting one service request. For example, this service request may be an HTTP web service request and one HTTP service request may include various requests such as a page file request and a resource request. In general, such plural requests are sequentially performed according to attributes of files and parallel simultaneous accesses may be performed on files of the same attribute. For example, a page file and a resource file are necessarily requested sequentially, whereas a plurality of resource files may be requested/responded to in parallel.

In step S420, the server responds to the plural requests received in step S410. For example, the server may transmit a page file to a client as a response or transmit a resource file to the client as the response.

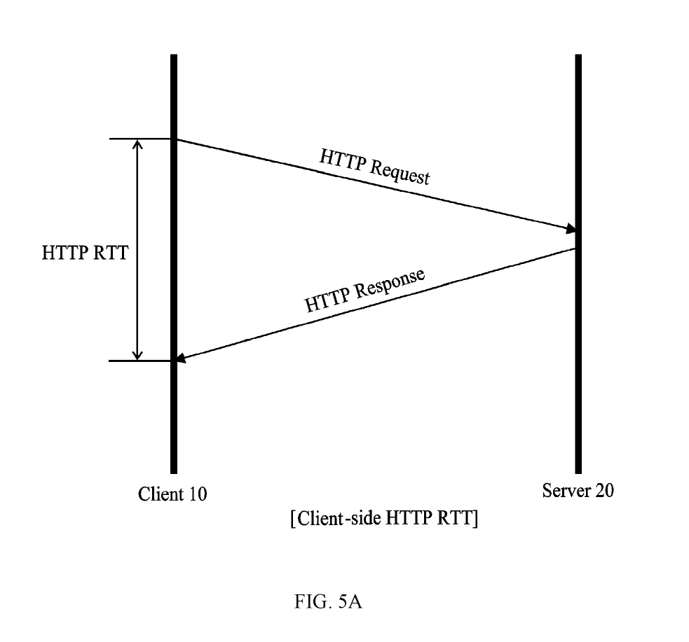

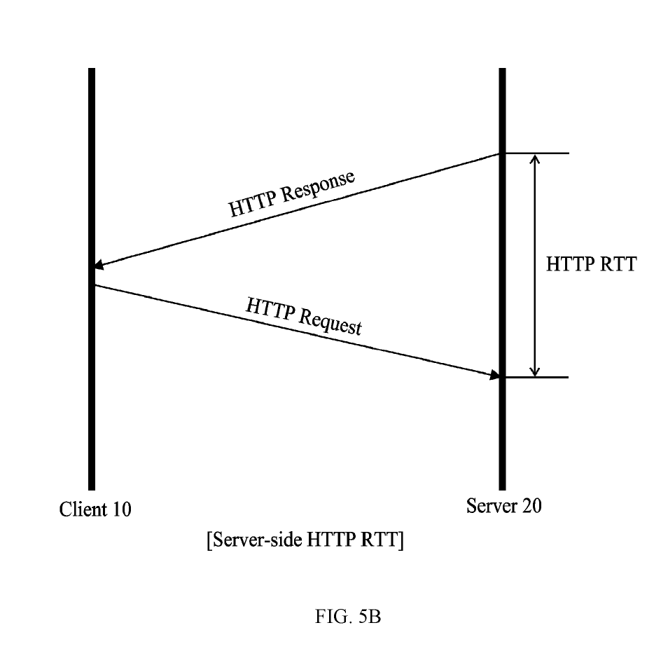

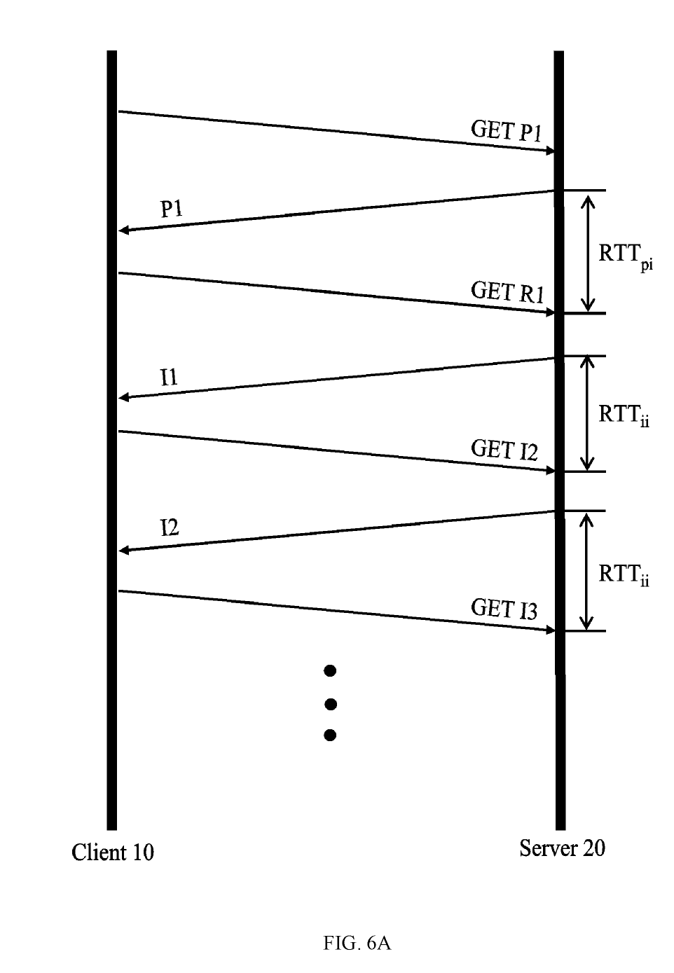

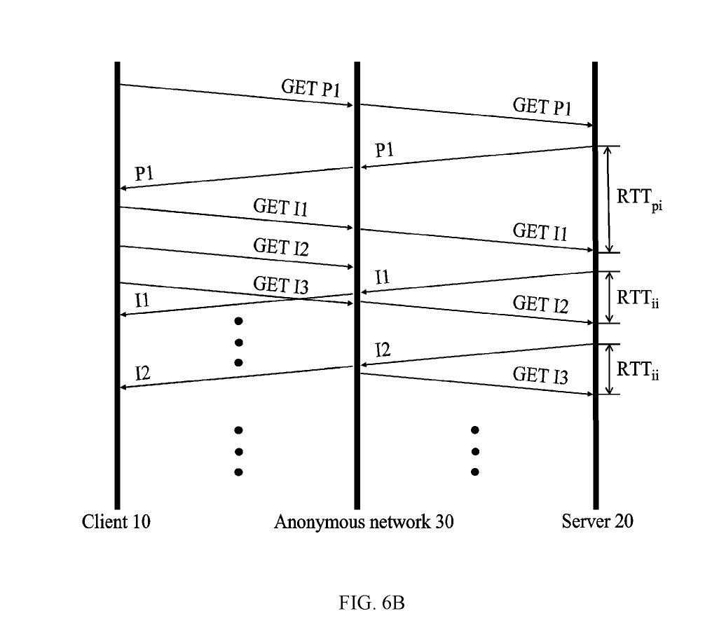

In step S430, the server measures RTTs according to the requests of step S410 and the responses of step S420. Details of measurement of the RTTs will be described later with reference to FIG. 5A to FIG. 6B.

In step S440 the server determines whether the service request is made by detoured access based on a difference in the RTTs measured in step S430. Determination as to whether the service request is made by detoured access is performed by checking whether irregularity occurs between the RTTs due to passing through an anonymous network. As described earlier in FIG. 3B, in the case of access via the anonymous network, there is a difference in communication paths between files to be transmitted and there is also a difference in the RTTs. Accordingly, when it is checked that the measured RTTs are irregular, corresponding access may be determined to be access via the anonymous network. As a result of determination, if it is estimated that the service request is made by detoured access, corresponding access may be disconnected.

More specifically, a procedure of determining whether the service request is made by detoured access in step S440 may be performed by calculating a difference between a first RTT according to a first request (e.g., a request for a page file) and a second RTT according to a second request (e.g., a request for a resource file) received by the server after responding to the first request, among a plurality of RTTs, and estimating that the service request is made by detoured access via the anonymous network when the difference is above a preset threshold value. In this case, the first RTT is an RTT based on communication between the server and a client and the second RTT is an RTT based on communication between the server and a detoured client located on the anonymous network. In addition, the first RTT includes a time delay caused by access via the anonymous network and has a relatively larger value than the second RTT.

FIG. 5A and FIG. 5B are views illustrating a method of measuring HTTP RTTs at a client side and a server side, respectively, in the detoured access detection method of FIG. 4. For convenience of description, an HTTP RTT will be described as an example of an RTT.

A simple RTT represents a time until a transmitter receives a response to a signal from a receiver after the transmitter transmits the signal to the receiver in a network. The factor most greatly affecting the RTT is distance and a medium of the network between the transmitter and the receiver. For the network of a long distance, an RTT value is large and, for the network of a short distance, the RTT value is small. In addition, if the medium of the network is a high-speed medium such as an optical cable, the RTT value is small and, if the medium of the network is a low-speed medium such as a copper cable, the RTT value increases. In consideration of the fact that most current wide-area networks consist of optical cables, a geographical distance of the network most greatly affects the RTT.

The HTTP RTT is a time until a client receives a response from a web server after the client transmits a request to the web server in an HTTP processing procedure. If the HTTP RTT is measured by the client 10, the HTTP RTT is a time from a request to a response of a normal form as illustrated in FIG. 5A. However, such a time measurement scheme is performed from the viewpoint of the client 10 and it is difficult to use this scheme from the viewpoint of the server 20 detecting detoured access, in which the present solution is implemented. Accordingly, a method of estimating an RTT from the viewpoint of the server 20 as illustrated in FIG. 5B needs to be used.

Referring to FIG. 5B, the web server 20 can measure the HTTP RTT by measuring a time interval from a response to a next request. In this situation, upon receiving the response, the client 10 should immediately transmit the next request to the server 20. Using this method, the server 20 may also estimate the RTT.

In summary, the RTT may be obtained by the client 10 by measuring a time consumed until the client 10 receives a response after transmitting a request to the server 20 or by the server 20 by measuring a time consumed until the server 20 receives a subsequent request after responding to a request.

FIG. 6A and FIG. 6B are views illustrating comparison of RTT measurement procedures using the detoured access detection method of FIG. 4 in a direct communication scheme and a communication scheme via an anonymous network.

As described earlier, a time until the client 10 requests a next file after obtaining a file from the server 20 according to a request may be accurately measured using the HTTP RTT measurement method. For convenience, a time until the client 10 requests a first resource file after getting a page file and a time until the client 10 requests a next resource file after getting the resource file are defined as RTTₚᵢ and RTTᵢᵢ, respectively. RTTₚᵢ and RTTᵢᵢ in normal access and RTTₚᵢ and RTTᵢᵢ in detoured access via the anonymous network 30 such as TOR are measured as illustrated in FIG. 6A and FIG. 6B, respectively.

With respect to one connection, one RTTₚᵢ value is measured for a page file, whereas multiple RTTᵢᵢ values may be measured for resource files. A minimum RTTᵢᵢ value is selected from among the multiple RTTᵢᵢ values. The minimum value corresponds to a value approximating to a pure communication delay because delay may occur due to reasons other than a communication delay in a procedure in which a corresponding exit node processes a request. When multiple connections are present, an arithmetic average of RTTₚᵢ values and an arithmetic average of RTTᵢᵢ values obtained with respect to the respective connections may be used. As an analysis result through an anonymous network experiment using TOR for a simulation in a process of proposing the present solution, RTTₚᵢ shows a higher value a few hundreds to thousands of times RTTᵢᵢ, whereas the two values are nearly the same in direct access.

In particular, in the detoured access detection method, the web server can accurately detect homepage detoured access via TOR only through an operation of simply analyzing traffic accessing the web server. Furthermore, there is no additional burden on the network and the web server at all and an argument about privacy intrusion does not occur at all.

As compared above, since the amount of HTTP response data may be large, an HTTP RTT is affected even by bandwidth of a network. For example, in the case of a train, even when the front part of a train passes through a distance of 10 thousand kilometers in one second, if the length of the train is 10 thousand kilometers, a passing time of the train is affected by a railroad. If one railroad is present, one second is further consumed but, if n railroads are present, a consumed time decreases by n times. If a relay server is present between the client and the web server, an additional delay occurs in a process in which the relay server receives data and performs encryption/decryption or confirms the contents of data. When TOR is used, since the case in which three relay servers are present is present (the case in which the three relay servers belong to different countries is frequently generated), a network distance remarkably increases and a considerable delay occurs (according to a research result, there is a report indicating that an Internet access speed may be delayed by ten times or more when TOR is used) due to encryption/decryption in a procedure of performing encryption communication between the client and the exit node. Therefore, the fact that the anonymous network is present between the client and the web server may be recognized through a procedure of observing a delay on a network which is necessarily generated when the anonymous network is used and analyzing in detail the timing and cause of the delay.

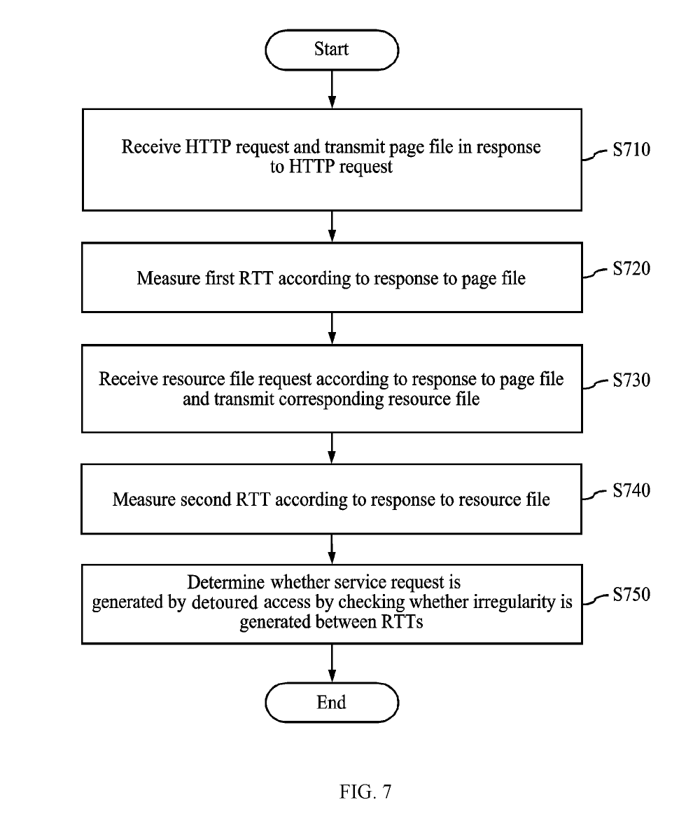

FIG. 7 is a flowchart illustrating a method of detecting detoured access via an anonymous network according to an HTTP service request of the present solution and the detoured access detection method of FIG. 4 described above is recomposed in FIG. 7 based on an HTTP service. Herein, only an overview of the detoured access detection method is described to avoid a repeated description.

In step S710, a server receives an HTTP request and transmits a page file in response to the received HTTP request. The transmitted page file arrives at a true client via an anonymous network and then is parsed. The client composes a list of resource files to be additionally called from the parsed result. The client requests that the server transmit the resource files based on the list of the resource files.

In step S720, the server measures a first RTT according to a response to the page file. The first RTT includes a time delay caused by passing through an anonymous network and has a larger value relative to a second RTT measured in step S740 because the second RTT is an RTT caused by a response to a resource file. The first RTT may be calculated as a time consumed until the server receives a request for a first resource file from the client after transmitting the response to the page file to the client using a communication path between the server and the client.

In step S730, the server receives a resource file request according to the response to the page file and transmits a corresponding resource file. The resource file is transmitted through communication with a false client constituting an anonymous network, i.e., an exit node, rather than with a true client.

In step S740, the server measures a second RTT according to a response to the resource file. The second RTT may be calculated as a time consumed until the server receives a request for a next resource file from the client after transmitting a response to the first resource file using a communication path between the server and a detoured client located on the anonymous network.

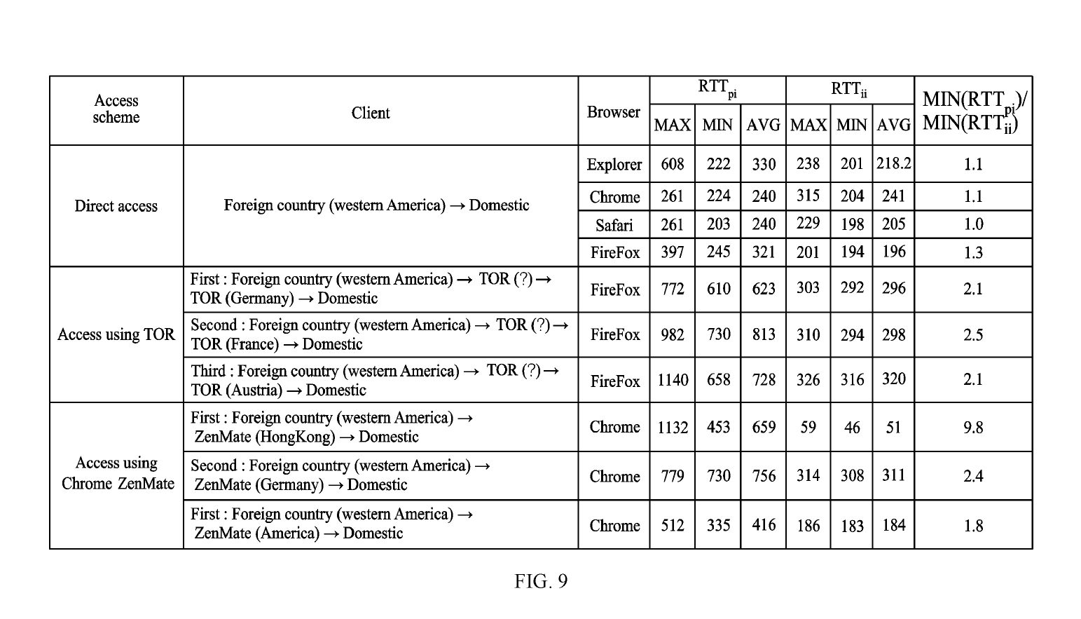

In step S750, the server determines whether a service request is generated through detoured access by checking whether irregularity is generated between the RTTs based on a difference between the first RTT and the second RTT measured respectively in step S720 and step S740. A procedure of determining whether there is detoured access may be performed by calculating a difference between the first RTT and the second RTT and estimating that the service request is made by detoured access via an anonymous network when the difference is above a present threshold value. If it is estimated that the service request is generated by detoured access in step S750, it is possible to identify the type of the anonymous network using a statistical distribution of the difference. In this case, the statistical distribution may use the range, deviation, time-series of difference and a more detailed description thereof will be given later with reference to FIG. 9.

When there is a plurality of target signals for measuring the first RTT and the second RTT, the respective RTTs are desirably calculated by measuring signals having minimum arrival times among the plural target signals.

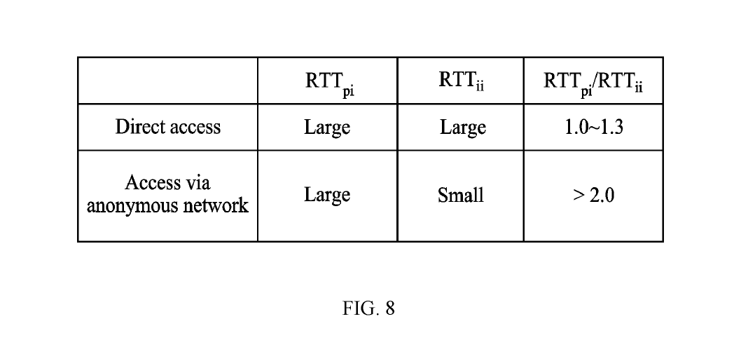

FIGS. 8 and 9 are views illustrating an experimental result of measuring RTTs under an assumption of various network environments.

Referring to FIG. 8, in the case of direct access, RTTₚᵢ and RTTᵢᵢ are measured as similar values with respect to both a remote distance and a short distance and, as a result, RTTₚᵢ/RTTᵢᵢ approximate to 1. In contrast, in the case of detoured access via an anonymous network, since RTTₚᵢ is relatively larger than RTTᵢᵢ, RTTₚᵢ/RTTᵢᵢ are calculated as greater than 2.

Referring to FIG. 9, a measurement result according to detoured access using ZenMate in addition to detoured access using TOR is shown. An experiment was performed using at least 4 open browsers. Even when a parsing delay time according to characteristics of browsers is considered, in the case of direct access, MIN(RTTₚᵢ)/MIN(RTTᵢᵢ) approximate to 1, whereas, in the case of detoured access using TOR or ZenMate, MIN(RTTₚᵢ)/MIN(RTTᵢᵢ) have large values more than double the values in the case of direct access.

Meanwhile, the present solution may be implemented as computer-readable code that can be written on a computer-readable recording medium. The computer-readable recording medium may be any type of recording device in which data that can be read by a computer system is stored.

Examples of the computer-readable recording medium include a ROM, a RAM, a CD-ROM, a magnetic tape, a floppy disk, an optical data storage, and a carrier wave (e.g., data transmission through the internet). The computer-readable recording medium can be distributed over a plurality of computer systems connected to a network so that a computer-readable code is written thereto and executed therefrom in a decentralized manner. Functional programs, code, and code segments needed to realize the present solution can be easily derived by programmers skilled in the art.

While the present solution has been described based on various embodiments. Those skilled in the art will appreciate that the present solution may be embodied in other specific forms than those set forth herein without departing from the spirit and essential characteristics of the present solution. The above description is therefore to be construed in all aspects as illustrative and not restrictive. The scope of the present solution should be determined by reasonable interpretation of the appended claims and all changes coming within the equivalency range of the present solution are intended to be embraced in the scope of the present solution.

According to the present solution, a server can accurately detect detoured access via an anonymous network by checking irregularity based on whether there is a difference between RTTs according to attributes of files through analysis of traffic accessing the server.

What is claimed is:

1. A method of detecting detoured access via an anonymous network, the method being performed by a server and comprising:
receiving a plurality of sequential requests constituting one service request;
responding to the received requests;
measuring round trip times (RTTs) according to the requests and responses, respectively; and
determining whether the service request is performed by detoured access based on a difference between the measured RTTs.

2. The method according to claim 1, wherein the determining is performed by checking whether irregularity between the RTTs occurs due to passing through the anonymous network.

3. The method according to claim 1, wherein the determining includes:
calculating a difference between a first RTT according to a first request among a plurality of RTTs and a second RTT according to a second request received by the server after responding to the first request among the RTTs; and
estimating that the service request is performed by detoured access via the anonymous network when the calculated difference is above a present threshold value.

4. The method according to claim 3,
wherein the first RTT is an RTT according to communication between the server and a client, and
the second RTT is an RTT according to communication between the server and a detoured client located on the anonymous network.

5. The method according to claim 3, wherein the first RTT includes a time delay caused by passing through the anonymous network and has a relatively larger value than the second RTT.

6. The method according to claim 1, wherein the RTTs are acquired by measuring times consumed until a client receives responses to requests after transmitting the requests to the server.

7. The method according to claim 1, wherein the RTTs are acquired by measuring times consumed until the server receives subsequent requests according to responses to requests after responding to the requests.

8. The method according to claim 1, further comprising disconnecting access upon estimating that the service request is performed by detoured access using the anonymous network.

9. A method of detecting detoured access via an anonymous network, the method being performed by a server and comprising:
receiving a hypertext transfer protocol (HTTP) request;
transmitting a page file in response to the received HTTP request;
measuring a first round trip time (RTT) according to a response to the page file;
receiving a request for a resource file according to the response to the page file and transmitting the resource file;
measuring a second RTT according to a response to the resource file; and
determining whether the service request is performed by detoured access by checking whether irregularity between RTTs occurs based on a difference between the measured first RTT and the measured second RTT.

10. The method according to claim 9, wherein the determining includes:
calculating a difference between the first RTT and the second RTT;
estimating that the service request is performed by detoured access via the anonymous network when the calculated difference is above a preset threshold value; and
identifying a type of the anonymous network using a statistical distribution of the calculated difference when it is estimated that the service request is performed by detoured access via the anonymous network.

11. The method according to claim 9, wherein the first RTT includes a time delay caused by passing through the anonymous network and has a relatively larger value than the second RTT.

12. The method according to claim 9,
wherein the first RTT is a time consumed until the server receives a request for a first resource file from a client after transmitting a response to the page file to the client using a communication path between the server and the client, and
the second RTT is a time consumed until the server receives a request for a next resource file from the client after transmitting a response to the first resource file using a communication path between the server and a detoured client located on the anonymous network.

13. The method according to claim 9, further comprising:
when a plurality of target signals for measuring the first RTT and the second RTT is present, calculating the RTTs by measuring signals having minimum arrival times among the target signals.
